(19) United States
(12) Patent Application Publication
(10) Pub. No.: US 2006/0074703 A1
(43) Pub. Date: Apr. 6, 2006

(54) Providing and managing business processes

(75) Inventors: Mangesh P. Bhandarkar, Mountain View, CA (US); John F. Linney, Saratoga, CA (US)

Correspondence Address: BEYER WEAVER & THOMAS LLP, P.O. BOX 70250, OAKLAND, CA, 94612-0250, US

(73) Assignee: Grand Central Communications, Inc.

(21) Appl. No.: 11/021,716

(22) Filed: Dec. 22, 2004

Related U.S. Application Data
(60) Provisional application No. 60/616,082, filed on Oct. 4, 2004.

(51) Int. Cl. G06Q 99/00; G07G 1/00

(52) U.S. Cl. 705/1; 705/10

(57) ABSTRACT

Methods and apparatus, including computer program products, implementing and using techniques for providing a business process over a network. A network connects several network nodes and a central repository. Each network node is associated with an organizational entity and represents a user, a service, or a computer application. The central repository, stores a business process describing a logical sequence of operations to be performed on data supplied to the business process, provides the business process to an organizational entity in response to a request from the organizational entity, receives customization data for the business process from the entity, which includes organization-specific data for the entity and further defines operations of the business process, and stores the received customization data such that the organization-specific data is retrievable by the associated business process and modifiable by a business user authorized by the organizational entity associated with the customized business process.

### CROSS-REFERENCE TO RELATED APPLICATIONS

The present application claims priority under 35 U.S.C. §119(e) from U.S. Provisional Patent Application No. 60/616,082 entitled “CONTROLLING BUSINESS PROCESSES AT RUNTIME” filed Oct. 4, 2004 (Attorney Docket No. GCENP013P), the entire disclosure of which is incorporated herein by reference for all purposes. The present application is also related to U.S. patent application Ser. No. 10/820,650 entitled “TECHNIQUES FOR PROVIDING INTEROPERABILITY AS A SERVICE” filed on Apr. 7, 2004 (Attorney Docket No. GCENP006), to U.S. patent application Ser. No. 10/727,089 entitled “APPARATUS AND METHODS FOR PROVISIONING SERVICES” filed Dec. 2, 2003 (Attorney Docket No. GCENP003), and to U.S. patent application Ser. No. 10/849,602 entitled “TECHIQUES FOR PROVIDING CONNECTIONS TO SERVICES IN A NETWORK ENVIRONMENT” filed May 19, 2004 (Attorney Docket No. GCENP008), the entire disclosures of all of which are incorporated herein by reference for all purposes.

### BACKGROUND

This invention relates to defining and modifying business processes.

A business process can be described as a series of specific events in a chain of structured business activities performed by one or more organizational entities. The business process typically changes the state of some business related data and/or a product and generates some type of output. Examples of different types of business processes include receiving orders, invoicing, shipping products, updating employee information, setting a marketing budget, and so on. Business processes occur at all levels of an organization's activities and can include both events that a customer can see and events that are invisible to the customer.

Organizations and businesses often implement business process flows in computer systems, in order to increase the efficiency with which a business process is performed, and to minimize the risk of errors occurring in the course of performing the business process. Implementing business process flows in computer systems also typically makes the business process flow more efficiently and allows a larger volume of data, such as purchase orders, invoices, and so on, to be processed by the computer system in a time-efficient and low-cost manner, compared to a situation in which some or all parts of the business process are performed manually by individuals.

There is a wide range of commercially available software products for creating and managing business process flows. Some examples include: the BEA WebLogic Workshop product by BEA Systems of San Jose, Calif. ; the Collaxa 2 product by Collaxa, Incorporated of Redwood Shores, Calif. ; the WebSphere product by International Business Machines, Incorporated, of Somers, N.Y.; the Microsoft BizTalk Server product by Microsoft Corporation of Redmond, Wash. ; and the Sun Web Service Choreography Interface (WSCI) Editor product by Sun Microsystems, Incorporated of Santa Clara, Calif.

A common drawback with most, if not all, of these types of business process software, is that the business process flows are typically “hard-coded” at design time. That is, the business process flow is decided at design time and it is difficult for a business user, such as a department manager within a company or an organization, to modify the business process. For example, a business process for handling purchase orders (POs) can be created that directs all POs over $10,000 to undergo a credit check. If a business user wanted to decrease the threshold for purchase orders from a particular customer, or during a particular time period, the business user would have to get the entire business process changed, typically by asking a programmer to implement the suggested changes.

In view of the above, there is a need for providing simpler control and design of business processes, not only at design time, but also at runtime, such that various parameters of a business process flow can be modified more easily by business users or decision makers, without having to modify the entire underlying business process and without having to use special expertise, such as programmers, to implement the requested modifications.

### SUMMARY

In general, in one aspect, the invention provides methods and apparatus, including computer program products, implementing and using techniques for providing a business process over a network. A network and a central repository are provided. The network connects several network nodes. Each network node is associated with an organizational entity and represents a user, a service, or a computer application. The central repository, which can be accessed through the network, stores a business process describing a logical sequence of operations to be performed on data supplied to the business process, provides the business process to an organizational entity in response to a request from the organizational entity, receives customization data for the business process from the organizational entity, which includes organization-specific data for the organizational entity and further defines operations of the business process, and stores the received customization data such that the organization-specific data is retrievable by the associated business process and modifiable by a business user authorized by the organizational entity associated with the customized business process.

Advantageous implementations can include one or more of the following features. The central repository can include a library of business processes, in which each business process is free of organization-specific data and describes a logical sequence of operations to be performed on data supplied to the business process, and from which library specified business processes can be requested and provided to one or more organizational entities. The central repository can include a tracking module for tracking modifications made to a business process by a business user. The customizing data can include one or more organization-specific policies for the business processes. The policies can be defined for a particular level of the organizational entity.

A computer application can provide a graphical user interface for customizing the business process, which includes several elements for receiving organization-specific data from a user. The central repository can modify the received customization data for a business process to alter the outcome of one or more operations of the business process, without changing the logical flow of the business process. The central repository can modify the received customization data based on input from a business user. The central repository can automatically modify the received customization data based on input received from a separate process that is associated with one or more of the operations of the business process.

A monitoring module can be provided that includes one or more external processes, which monitors an organization-specific business process at runtime and automatically modifies the received customization data at runtime, based on criteria specified in the external processes and based on the results of the monitoring. The central repository can include several data storage areas for storing customization data for the business process, where each data storage area is associated with an organizational entity. The organizational entity can represents one or more individual users. The network can be an interoperability network that includes functionality for routing business process messages through the interoperability network and functionality for mediating differences in communication protocol formats between users, services, and computer applications associated with the business process.

In general, in another aspect, the invention provides methods and apparatus, including computer program products, implementing and using techniques for providing a business process. A business process is provided that describes a logical sequence of operations to be performed on data supplied to the business process. Access to the business process is granted to an organizational entity. The business process is customized for the organizational entity into an organization-specific business process, which includes providing organization-specific data for the organizational entity that further defines the operations of the business process. The organization-specific data is stored in a repository from which the organization-specific data can be retrieved by the organization-specific business process and modified by a business user authorized by the organizational entity associated with the organization-specific business process.

Advantageous implementations can include one or more of the following features. Providing a business process can include providing a library of business processes, where each business process is free of organization-specific data and describes a logical sequence of operations to be performed on data supplied to the business process, from which library specified business processes can be requested and provided to one or more organizational entities. Modifications made by a business user to an organization-specific business can be tracked to create an audit trail of the modifications that were made to the organization-specific business process. Customizing the business process can include customizing the business process for the organizational entity into an organization-specific business process, based on organization-specific policies. The policies can be defined for a particular level of the organizational entity. Customizing the business process can include providing a graphical user interface for customizing the business process, which includes several elements for receiving input from a user; and customizing the business process by entering organization-specific data for the business process into the elements of the graphical user interface.

An execution path of the organization-specific business process can be modified to alter the outcome of one or more operations of the business process, without changing the logical flow of the business process. Modifying can include receiving input from a business user for modifying the execution path of the organization-specific business process and modifying the execution path of the organization-specific business process, based on the received input. Modifying can include automatically modifying the execution path of the organization-specific business process, based on input received from a separate process that is associated with one or more of the operations of the organization-specific business process. An organization-specific business process can be monitored at runtime with one or more external processes and the execution path of the organization-specific business process can be automatically modified at runtime, based on criteria specified in the external processes and based on the results of the monitoring. Granting access can include granting a role to a business user associated with the organizational entity, where the role has a set of associated permissions defining one or more operations that the business user can perform on the business process.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1A shows the provisioning of a service for use over an interoperability network.

FIG. 1B shows the mediation of messages sent from a first service to a second service through an interoperability network in accordance with one implementation of the present invention.

FIG. 2 is a flowchart showing an exemplary business process that can be implemented in the interoperability network of FIG. 1A.

Like reference symbols in the various drawings indicate like elements.

### DETAILED DESCRIPTION

The present invention provides methods and apparatus, including computer program products, for controlling business processes at run time based on policies and without needing to modify a business process flow.

The invention can be implemented to include one or more of the following advantages, which will be apparent upon reading the following description. Business users can tailor the behavior of a business process to their particular requirements without needing to consult a business analyst or developer to “re-code” the business process. The decoupling of the actual logical flow of the business process from the policies involved in making decisions in the business process enables business processes to be more shareable and manageable. A single business process can be shared by multiple departments and managed as a single instance, while allowing business users, such as department managers to decide different, department-specific policies on how the execution of the business process should proceed under various conditions. The invention decouples the “design-time” decisions about the business process flow from the “run-time” requirements which can be much more dynamic and be adjusted based on other events or circumstances that prevail outside the business process at runtime.

The invention will be described in detail with reference to specific implementations including the best modes contemplated by the inventors for carrying out the invention. Examples of these specific implementations are illustrated in the accompanying drawings. While the invention is described in conjunction with these specific implementations, it will be understood that this description is not intended to limit the invention to the described implementations. On the contrary, the description is intended to cover alternatives, modifications, and equivalents as may be included within the spirit and scope of the invention. In the following description, specific details are set forth in order to provide a thorough understanding of the present invention. The present invention can be practiced without some or all of these specific details. In addition, well known features or details may not have been described to avoid unnecessarily obscuring the invention.

According to various implementations of the invention, an interoperability network (106) is provided which facilitates interoperability and implementation of business processes using, among other things, a wide variety of web services technologies and standards including, for example, Simple Object Access Protocol (SOAP), Web Services Description Language (WSDL), WS-Security, WS-Policy, and Business Process Execution Language (BPEL). The interoperability network (106) mediates the technology differences in data formats, communications protocols and business policies through a set of established and defined policies.

In general, the term ‘web service’ refers to a collection of technology standards that enable software applications of all types to communicate over a network. A web service typically facilitates a connection between two applications or services in which queries and responses are exchanged in XML (eXtended Markup Language) over HTTP (Hyper Text Transfer Protocol) or HTTPS (Secure HTTP). More specifically, the term web services implies the implementation of a stack of specific, complementary standards.

Although not specifically tied to any transport protocol, web services build on Internet connectivity and infrastructure to ensure nearly universal reach and support. In particular, web services take advantage of HTTP, the same connection protocol used by Web servers and browsers. XML (and its corresponding semantics) is a widely accepted format for exchanging data, and is a fundamental building block for nearly every other layer in the web services stack. SOAP is a protocol for messaging between applications. SOAP is based on XML and uses common Internet transport protocols, such as HTTP, to carry its data. Web Services Description Language (WSDL) is an XML-based description of how to connect to and communicate with a particular web service. A WSDL description abstracts a particular service's various connection and messaging protocols into a high-level bundle and forms a key element of the UDDI directory's service discovery model. Finally, Universal Description, Discovery, and Integration (UDDI) represents a set of protocols and a public directory for the registration and real-time lookup of web services and other business processes. Various implementations of the invention employ these and similar technologies to provide interoperability in a business process between and among disparate platforms, services or applications as a service.

Specific mechanisms by which the interoperability network (106) can facilitate interaction among a variety of entities will now be described with reference to the accompanying figures. It will be understood that the mechanisms described are merely examples of techniques that can be employed to facilitate the basic functionalities of such interoperability networks. That is, any technologies that facilitate “on-demand” access to a wide range of services are within the scope of the invention.

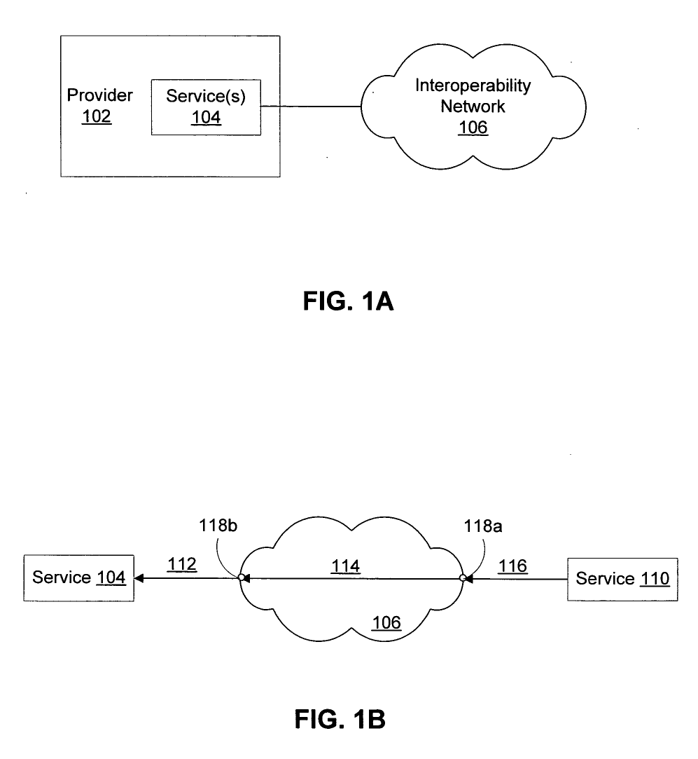

FIG. 1 illustrates the provisioning of a service (104) through a network in accordance with one implementation of the present invention. As shown, the network includes an interoperability network (106) for facilitating the provisioning of services for use by entities having access to the interoperability network (106). In a specific example, a service (or set of services) (104) is provisioned by a service provider (102) in conjunction with interoperability network (106). During the provisioning process, format connection, and security preferences can be specified for messages received by the services (104) as further described below. In one implementation, provisioning includes setting up a service configuration such that the service (104) can be used in the interoperability network (106). As part of this set up, the services (104) can specify the type of message format they prefer to receive. The respective services (104) can reside either inside or outside the firewall of their service providers (102).

In some implementations, the service provider (102) can optionally specify which users or services can access the provisioned service (104) and the conditions under which they can have access. It should be recognized that the services (104) can be provided by the service provider (102) to any type of entity such as, for example, an individual user from a particular organization or a particular organizational entity. An entity can represent a distinct business entity, a particular user within a business entity, or an administrative domain of a computer application.

As used herein, the term “service” can represent any computer application, process, entity, or device accessible to other applications, processes, entities, or devices through an interface such as an application programming interface (API), user interface, or Internet web user interface by any of a variety of protocols over a network within an entity or over the Internet. A service can also comprise multiple methods or applications on a single device or distributed across multiple devices.

Although not shown in FIG. 1, a service provider (102) can provision any number and type of services (104). Also, any number and type of service providers (102) can provision services (104) to be accessed through the interoperability network (106). Accordingly, the interoperability network (106) can be configured to provision multiple services (104) from multiple service providers (102). A specific example of how service providers can provision services has been described in U.S. patent application Ser. No. 10/727,089 entitled “APPARATUS AND METHODS FOR PROVISIONING SERVICES” filed Dec. 2, 2003, and incorporated herein by reference above.

After services (104) are provisioned, messages can then be sent between two or more services (104) through the interoperability network (106). That is, a particular service (104) can be accessed by another service through the interoperability network (106). For example, a user associated with a first device can access a particular service on a second device through the interoperability network (106) using a communication process (or service) located on the first device.

FIG. 1B illustrates the mediation of messages sent from a first service (110) to a second service (104) through an interoperability network (106) in accordance with a particular implementation of the present invention. As shown, a message is being sent from a first service (110) to a second service (104) through the interoperability network (106), which is accessible over a wide area network such as, for example, the Internet. Such a message can correspond to a request from a user associated with the first service (110) for access to the second service (104), which resides on a remote device. The request can be sent to the second service (104) by a web application (for example, the first service (110)) located on another remote device. In particular cases, the first service (110) and second service (104) can be configured to execute on their own and a user is not required to send a request or message to a particular service.

In one configuration, the interoperability network (106) can include any number of mechanisms for mediating communications between two or more services (110; 104). In the illustrated implementation, the interoperability network (106) includes a mechanism for translating messages sent between the services (110; 104). Messages can use formats such as MIME (Multipurpose Internet Mail Extension), DIME (Direct Internet Message Encapsulation), and the like, with AS2 (Applicability Statement 2), SOAP, and other application bindings. MIME and DIME are attachment/part formats, while SOAP and AS2 are application logic binding protocols. Of course, a message can use any suitable type of protocol, structuring, or formatting specification, which results in a particular format for the message. When different entities use different formats for their messages, the interoperability network (106) translates the messages such that recipients receive the messages in the appropriate format.

In an exemplary implementation, a message having a MIME format is sent by the first service (110) and received into the interoperability network (106) through a first routing path (116). Of course, the first routing path (116) can include any number and type of routers and/or processing nodes. The interoperability network (106) then determines, for example, through policies in the directory, that the second service (104) expects messages to be received in a DIME format and translates the message from MIME to DIME along a second routing path (114). The second routing path (114) can include any number and type of routing devices (or services) and/or processing device (or services). The translated message, which is now in DIME format, is then sent to the second service (104) through a third routing path (112), which can include any suitable number and type of routing devices and/or processing nodes.

In addition to transformation of messages, any number of other enrichments can be applied to messages in the interoperability network (106). Such enrichments can include, for example, a digital signature service, a tariff calculator for a purchase order, and so on.

According to various implementations, the first service (110) and the service provider of the first service (110) need not be aware of the message format requirements of the message destination (that is, the second service (104)), nor of any format translation taking place in the interoperability network (106). The first service (110) can send the message as if the second service (104) employed the same message format as used by the first service (110).

In addition to providing mechanisms for provisioning services and mediating messages sent to such services, the interoperability network (106) also preferably includes a repository or a directory for storing various information regarding the services (110; 104) and entities that provision and/or use such services. This information can include, for example, user identities, service identities and policies, that control which entities in the interoperability network (106), can interact, and the manner in which the entities can interact. The interoperability network (106) can also include mechanisms for creating and combining services, registering users and their identifying information, and handling messages routed between services (110; 104) and/or users. The repository can be formed from one or more databases or directory services, including LDAP, or the like stored on one or more memory devices on one or more computing platforms.

In some implementations of the invention, the interoperability network (106) provides security management including authentication, authorization and security policy enforcement using the information in the directory and policy framework. The interoperability network (106) can perform security management at various points in a message's network lifecycle, for example, when a message is sent into the interoperability network (106) from a service (104), when the message is routed to its destination endpoint (118b), and when the message is delivered out of the interoperability network (106) to its destination service (104). While the following discussion employs the term “service,” it will be understood that this is intended to include all application and software entities capable of connecting to and interacting with the interoperability network (106), in particular in order to carry out a business process.

Authentication is the process of verifying that users or services (110; 104) interacting through the interoperability network (106) have valid network identities. The authentication process can involve the interoperability network (106) supplying credentials required by the service (110; 104) to identify the interoperability network (106). Authorization is the process of making sure a service (110) has permission to exchange messages with another service (104). Security policy enforcement allows services (110; 104) to specify the level of security other services (110; 104) must employ to interact with them through the interoperability network (106). For example, if the first service (110) has a security policy of required encryption for data and required password authorization or better, then only services connecting to the interoperability network (106) with a connection security policy that requires at least data encryption will be allowed to exchange messages with the first service (110). Service providers (102) can define equivalent security policies, allowing the interoperability network (106) to consider certain policies to be equivalent to others, though they are not the same, for the purpose of gaining access to services (110; 104).

According to a specific implementation, a service identity is the network service address of an interoperability network endpoint (118a) with which the connecting service (110) is associated. The service proof is the password configured for the associated endpoint. The user identity is a combination of organization and user name. Optionally a service name can be provided with the user identity. The user identity associates the connecting service (110) with the corresponding network user account.

When a service (110; 104) posts a message to the interoperability network (106) or polls for a message, the service (110; 104) initiates a connection to the interoperability network (106). The service (110; 104) is authenticated and associated with an endpoint (118a; 118b) on the interoperability network (106). The interoperability network (106) verifies that the connection security policy of the connecting service is at least as high as the connection security policy defined by the associated endpoint. If the authentication and security policy checks pass for a posted message, the message is accepted into the interoperability network (106) and is ready to be routed. Otherwise the message is not accepted and a SOAP fault is returned to the service. If the service (110; 104) is polling for a message and verification succeeds, the message requested by the poll is delivered to the service. If security verification fails, a SOAP fault is returned to the service (110; 104) and the polled for message is not delivered.

When connecting to the interoperability network (106) the service (110; 104) supplies a username that identifies the service (110: 104) as an identity on the interoperability network (106). The provided identity associates the connecting service (110; 104) with an endpoint service (118a; 118b) on the interoperability network (106). In addition, the service (110; 104) supplies a password and/or a client certificate as proof of that identity. In the case of HTTPS connections, the interoperability network (106) provides a server certificate that can be used by the service for authentication of the interoperability network (106).

As mentioned above, each service (110; 104) must connect with a security level that is the same or higher than the connection security policy configured for the service's associated endpoint service (118a; 118b) which can be configured, for example, for HTTP, HTTPS (HTTP with encryption) or HTTPS with certificate-based authentication.

The interoperability network (106) determines the endpoint (118a; 118b) associated with a message and routes the message to a message queue associated with that endpoint (118a; 118b). During this routing phase, security policy and permission verification is performed. If the security policy and permission verification passes, the message is routed to the message queue associated with the destination endpoint (118a; 118b). If either part of the verification does not pass, the message is not routed and a SOAP fault is returned to the service (110; 104) that originated the message.

Security policies are enforced in a bidirectional manner. That is the security policy of the connecting service's endpoint (that is, the origin endpoint (118a)) and the security policy of the destination service's endpoint (that is, the destination endpoint (118b)) must both be met. For example, if the origin endpoint (118a) has a security policy of HTTP, the origin endpoint (118a) will allow services (110; 104) that use HTTP or HTTPS to connect. However, the only endpoints the origin endpoint (118a) will be allowed to message with are endpoints with a security policy that allows HTTP. That is, endpoints with a security policy of HTTPS or higher will not allow services that connect with HTTP to message with the service associated with them.

Permission enforcement can also performed during the message routing phase. The destination endpoint has a permissions or access control list policy that is stored in the directory that the interoperability network (106) references to determine whether or not the origin endpoint (118a) is allowed to exchange messages with this destination endpoint (118b).

When the interoperability network (106) pushes a message to a destination service (104), the interoperability network (106) can perform authentication of the service (104), can provide authentication credentials to the service (104), and will enforce the connection security policy configured for the endpoint corresponding to the destination service (104). If authentication verification and security policy validation succeed, the message is delivered to the destination service (104). If either security verifications fail, the message is not delivered and a SOAP fault can be returned to the service (110) that originated the message.

When connecting from the interoperability network (106) to a destination service (104), the interoperability network (106) can be configured to provide no authentication credentials, to supply a username and/or password, or to authenticate a digital certificate (e.g., a Verisign X.509 certificate) sent by the destination service (104) to the interoperability network (106). In addition, the interoperability network (106) can be configured to supply a digital certificate, which the destination service (104) can use to authenticate the interoperability network (106). It will be understood that the foregoing description relating to security management is merely exemplary and that any suitable alternatives for providing any combination of the described functionalities are within the scope of the invention.

As can be understood from the foregoing discussion, the features of the interoperability network (106) lend themselves particularly well to implementing business processes, as the interoperability network (106) enables the necessary underlying protocol functionality and mediates any differences in protocol formats between various services (110; 104) and applications.

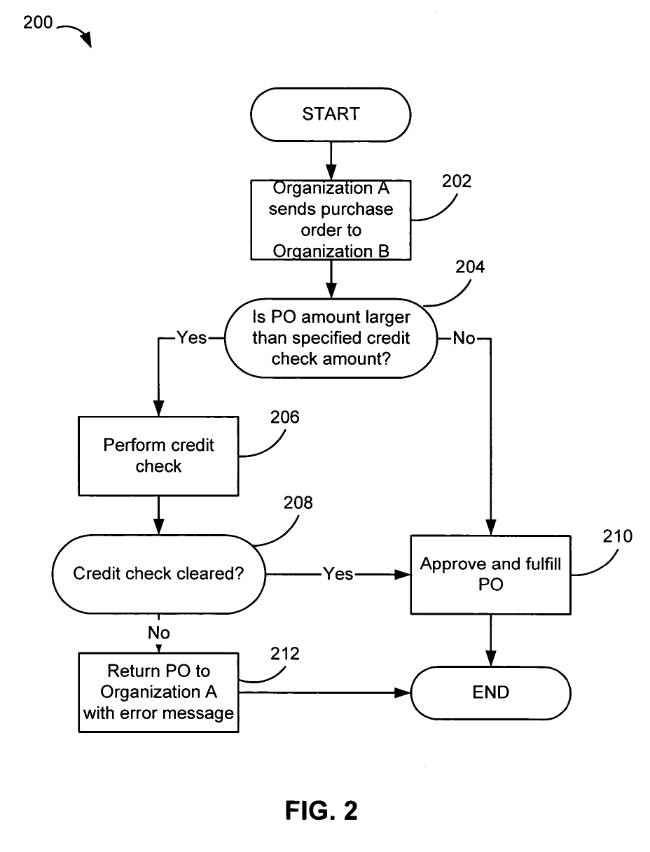

FIG. 2 shows a flowchart of a simple business process (200) that will be used herein to illustrate the invention by way of example. The business process (200) of FIG. 2 involves two organizations, organization A and organization B that are connected to the interoperability network (106). Organization A and organization B can represent, for example, departments or offices within the same company, two separate companies, two individuals, or any combination of the above. As can be seen in FIG. 2, the business process (200) starts with organization A sending a purchase order (PO) to organization B through the interoperability network (106) (step 202). The PO includes information stating that the PO is associated with organization A. Organization B has a PO value policy stating that when a received PO is larger than a specified amount, a credit check should be performed before approving and filling the PO. In one implementation the PO value policy is stored in the repository of the interoperability network (106), but in other implementations, the PO value policy can be stored within organization B or at any other location designated by organization B, from which the PO value policy can be accessed.

The next step of the business process is to check whether the amount of the PO is larger than the specified amount (step 204), which is done by accessing the PO Value policy for organization B in the repository. If, upon checking the PO Value policy for organization B in the repository, the process discovers that the amount of the PO is larger than or equal to the specified amount, the business process continues by performing a credit check (step 206). If the credit check clears (step 208) or if the amount of the PO is smaller than the specified amount in organization B's policy, then the PO is approved and fulfilled (step 210) and the business process ends. If the credit check does not clear in step 208, then the PO is returned to organization A along with a message stating that the PO could not be fulfilled because the credit check did not clear (step 212), and the process ends.

The above-described simple business process can be of interest not only to organization A and organization B, but also to other organizations or companies, such as, an organization C that also has a policy to perform a credit check when a PO exceeds a particular amount. This particular amount may be different from the amount for organization B above, for example, depending on what type of products organization B and organization C provide. However, since the business process of FIG. 2 is described in general terms, without any specific parameters, the business process (200) can be directly transferred to and implemented in organization C, which can create its own PO value policy for credit check limits, and store this policy in organization C's associated storage area of the repository in the interoperability network (106). When a PO is received by organization C, organization C's policy is retrieved from the repository and is used to evaluate whether a credit check should be performed.

This parameter-free “template” for the simple business process described above, in which the logic of the business process flow is separated from the organization-specific parameters, makes it possible to easily share the business processes between organizations. Even two competing organizations can use the same business process, and keep their own policies and parameters confidential. In one implementation of the invention, a library of standard business processes for various business scenarios is provided on and accessed through the integration services network (106). Different organizational entities select business processes that are appropriate for their organizations and subsequently add their own policies, which typically are specific to the context in which the organizations operate.

In one implementation of the invention, business users within an organization, such as department managers within a company, can be granted access by the organization to change policies associated with the organization. A simple drag-and-drop user interface, or a set of dialog boxes can be provided, in which the business user can enter values for specific policies, which values are subsequently stored in the central repository and applied to the relevant business processes. For example, a retail company can have a default policy stating that a credit check should be made every time a PO is received that has a value greater than $10,000. However, during the holiday season, when typically a very large number of transactions occur, it may be costly and time consuming to perform a credit check every time a PO comes in with a value greater than $10,000. A business user, such as sales department manager of the retail company, who has been authorized by the company to change the policies, can then temporarily relax the credit check policy, such that a credit check is only performed for received POs of a value greater than $25,000, for example. When the holiday season is over, the credit check policy can be changed back by the sales department manager to the normal level of $10,000. In one implementation of the invention, changes made by the business user are tracked within the interoperability network (106), to establish a complete audit trail of the activities of the business user.

It should be noted that the policies in the repository can be defined for any organizational level, such as separate organizations or companies, departments or sub-organizations within an organization, all the way down to an individual level. The rights to change policies can also be given or delegated to any desired organizational level, such that, for example, a person who works in a sales department of a company can change the policy for when a credit check should occur.

In one implementation, not only business users but also processes, such as other business processes or various types of monitoring processes, can change the policies for a given business process during runtime. As an example, consider a vendor managed inventory (VMI) situation in which gasoline in a tank should be reordered as soon as the contents of the gasoline tank reaches a particular level (that is, a policy states “if the fill level of the tank goes under 30% of the tank's maximum capacity, order more gasoline”). A second process can monitor the rate at which the tank is being emptied. This second process can include a policy stating “if the rate at which the gasoline tank is being emptied increases by 15% or more, change the reorder policy to occur at 50% of the maximum capacity, instead of 30% of the maximum capacity.” Thus, in this example the second process for monitoring the rate controls the first reordering process. The first process can also be controlled by other types of processes; for example, a third process can monitor gasoline prices. If the third process discovers that the gasoline prices drop rapidly, the third process can change the reordering policy for the first process such that reordering of gasoline occurs earlier, for example, at a fill level of 70% instead of the usual 30%. There can also be situations in which two separate processes, such as the second and third processes described above, cooperate in controlling the first business process. As can be seen from the above example, many “layers” of business processes and policies can be created and the different business processes can be performed with various degrees of automation.

Thus, the abstraction of the organization-specific parameters from the logical flow of the business processes makes it possible to modify a business process at any time after the business process has been coded, and without affecting the programming code describing the logical flow of the business process. The modifications to the business process can either be made by people or by automated processes (or a combination of people and processes) that have a solid understanding of how the business process works and that have been given the necessary privileges, as defined by the owner of the business process, to modify the business process. As a result, a better control of the business processes can be achieved, and the business processes can be more responsive to changes in the environment in which they are executed. Furthermore the abstraction of the organization-specific parameters from the logical flow of the business processes facilitates sharing and reusing of the business processes.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor optionally can be coupled to a computer or telecommunications network, for example, an Internet network, or an intranet network, using a network connection, through which the processor can receive information from the network, or might output information to the network in the course of performing the above-described method steps. Such information, which is often represented as a sequence of instructions to be executed using the processor, can be received from and outputted to the network, for example, in the form of a computer data signal embodied in a carrier wave. The above-described devices and materials will be familiar to those of skill in the computer hardware and software arts.

It should be noted that the present invention employs various computer-implemented operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

The present invention also relates to a device, system or apparatus for performing the aforementioned operations. The system can be specially constructed for the required purposes, or it can be a general-purpose computer selectively activated or configured by a computer program stored in the computer. The processes presented above are not inherently related to any particular computer or other computing apparatus. In particular, various general-purpose computers can be used with programs written in accordance with the teachings herein, or, alternatively, it can be more convenient to construct a more specialized computer system to perform the required operations.

A number of implementations of the invention have been described. Nevertheless, it will be understood that various modifications can be made without departing from the spirit and scope of the invention. For example, the invention has been described above in the context of an interoperability network, but it should be clear to the reader that any type of network that is capable of communicating information between different organizations and has a central storage capability for user-specific policies can be used. Also, a large part of the discussion above has been focused on business processes involving purchase orders. These examples were merely chosen as easy to understand examples that clearly illustrate the various features of the invention, and should not be construed to be limited. The principles of the invention can be used in much more complicated business processes.

1. A system for providing a business process over a network, the system comprising:
a network connecting a plurality of network nodes, each network node being associated with an organizational entity and representing one or more of: a user, a service, and a computer application;
a central repository that is accessible through the network and operable to:
store a business process describing a logical sequence of operations to be performed on data supplied to the business process;
provide the business process to an organizational entity in response to a request from the organizational entity;
receive customization data for the business process from the organizational entity, the customization data including organization-specific data for the organizational entity and further defining operations of the business process; and
store the received customization data such that the organization-specific data is retrievable by the associated business process and modifiable by a business user authorized by the organizational entity associated with the customized business process.

2. The system of claim 1, wherein the central repository includes:
a library of business processes, wherein each business process is free of organization-specific data and describes a logical sequence of operations to be performed on data supplied to the business process, from which library specified business processes can be requested and provided to one or more organizational entities.

3. The system of claim 1, wherein the central repository includes:
a tracking module for tracking modifications made to a business process by a business user.

4. The system of claim 1, wherein the customizing data includes one or more organization-specific policies for the business processes.

5. The system of claim 4, wherein the policies are defined for a particular level of the organizational entity.

6. The system of claim 1, further comprising:
a computer application providing a graphical user interface for customizing the business process, the graphical user interface including a plurality of elements for receiving organization-specific data from a user.

7. The system of claim 1, wherein the central repository is further operable to:
modify the received customization data for a business process to alter the outcome of one or more operations of the business process, without changing the logical flow of the business process.

8. The system of claim 7, wherein the central repository is operable to modify the received customization data, based on input from a business user.

9. The system of claim 7, wherein the central repository is operable to automatically modify the received customization data, based on input received from a separate process that is associated with one or more of the operations of the business process.

10. The system of claim 1, further comprising:
a monitoring module including one or more external processes operable to:
monitor an organization-specific business process at runtime; and
automatically modify the received customization data at runtime, based on criteria specified in the external processes and based on the results of the monitoring.

11. The system of claim 1, wherein the central repository includes:
a plurality of data storage areas for storing customization data for the business process, each data storage area being associated with an organizational entity.

12. The system of claim 1, wherein the organizational entity represents one or more individual users.

13. The system of claim 1, wherein the network is an interoperability network including functionality for routing business process messages through the interoperability network and functionality for mediating differences in communication protocol formats between users, services, and computer applications associated with the business process.

14. A computer-implemented method for providing a business process, the method comprising:
providing a business process describing a logical sequence of operations to be performed on data supplied to the business process;
granting access to the business process to an organizational entity;
customizing the business process for the organizational entity into an organization-specific business process, including providing organization-specific data for the organizational entity, the organization-specific data further defining the operations of the business process; and
storing the organization-specific data in a repository from which the organization-specific data is retrievable by the organization-specific business process and modifiable by a business user authorized by the organizational entity associated with the organization-specific business process.

15. The method of claim 14, wherein providing a business process includes:
providing a library of business processes, wherein each business process is free of organization-specific data and describes a logical sequence of operations to be performed on data supplied to the business process, from which library specified business processes can be requested and provided to one or more organizational entities.

16. The method of claim 14, further comprising:
tracking modifications made by a business user to an organization-specific business, to create an audit trail of the modifications that were made to the organization-specific business process.

17. The method of claim 14, wherein customizing the business process includes:
customizing the business process for the organizational entity into an organization-specific business process, based on organization-specific policies.

18. The method of claim 17, wherein the policies are defined for a particular level of the organizational entity.

19. The method of claim 14, wherein customizing the business process includes:
providing a graphical user interface for customizing the business process, the graphical user interface including a plurality of elements for receiving input from a user; and
customizing the business process by entering organization-specific data for the business process into the plurality of elements of the graphical user interface.

20. The method of claim 14, further comprising:
modifying an execution path of the organization-specific business process to alter the outcome of one or more operations of the business process, without changing the logical flow of the business process.

21. The method of claim 20, wherein modifying includes:
receiving input from a business user for modifying the execution path of the organization-specific business process; and
modifying the execution path of the organization-specific business process, based on the received input.

22. The method of claim 20, wherein modifying includes:
automatically modifying the execution path of the organization-specific business process, based on input received from a separate process that is associated with one or more of the operations of the organization-specific business process.

23. The method of claim 14, further comprising:
monitoring an organization-specific business process at runtime with one or more external processes; and
automatically modifying the execution path of the organization-specific business process at runtime, based on criteria specified in the external processes and based on the results of the monitoring.

24. The method of claim 14, wherein granting access includes:
granting a role to a business user associated with the organizational entity, the role having a set of associated permissions defining one or more operations that the business user can perform on the business process.

25. A computer program product, stored on a machine-readable medium, comprising instructions operable to cause a computer to:
provide a business process describing a logical sequence of operations to be performed on data supplied to the business process;
grant access to the business process to an organizational entity;
customize the business process for the organizational entity into an organization-specific business process, including providing organization-specific data for the organizational entity, the organization-specific data further defining the operations of the business process; and
store the organization-specific data in a repository from which the organization-specific data is retrievable by the organization-specific business process and modifiable by a business user authorized by the organizational entity associated with the organization-specific business process.
